(19) United States
(12) Patent Application Publication
(10) Pub. No.: US 2023/0311458 A1
(43) Pub. Date: Oct. 5, 2023

(54) A HEAT-SEALABLE PACKAGING FILM

(71) Applicant: Danapak Flexibles A/S, Slageise (DK)

(72) Inventors: Peter Johansen, Odense (DK); Rasmus Buch Moller, Ringsted (DK)

(21) Appl. No.: 18/010,328

(22) PCT Filed: Jul. 1, 2021
(86) PCT No.: PCT/EP2021/068162

§ 371 Date: Dec. 14, 2022

(30) Foreign Application Priority Data
Jul. 1, 2020 (EP) 20183572.5

(51) Int. Cl. B32B 27/08; B29C 48/10; B29C 48/21; B32B 27/36

(52) U.S. Cl. CPC B32B 27/08; B29C 48/10; B29C 48/21; B32B 27/36; B29K 2067/003; B29K 2995/0012

(57) ABSTRACT

A heat-sealable packaging film, comprising a base film mainly comprising polyethylene terephthalate, the base film forming a layer of the packaging film; and a heat seal layer mainly comprising an IPA-modified copolyester; wherein the heat seal layer has been extrusion coated on the base film so that the heat seal layer material forms an exterior, amorphous, and heat- sealable heat seal layer.

### CROSS-REFERENCE

The present application is the national phase entry under 35 U.S.C. 371 of International Patent Application No. PCT/EP2021/068162 by Johansen et al., entitled “A HEAT-SEALABLE PACKAGING FILM”, filed Jul. 1, 2021, and claims the benefit of EP Patent Application No. 20183572.5 by Johansen et al., entitled “A HEAT-SEALABLE PACKAGING FILM”, filed Jul. 1, 2020, each of which is assigned to the assignee hereof and is incorporated by reference in its entirety.

### TECHNICAL FIELD

The present disclosure relates to heat-sealable packaging films and methods of manufacture of such packaging films, wherein the packaging films comprise a polyester base film and a polyester heat seal layer applied on the base film by (co-)extrusion coating.

### BACKGROUND

It is known to coextrusion coat an exterior heat-sealable polyethylene terephthalate (PET) layer on PET films to provide a heat-sealable packaging film. The heat seal layer material that is coextrusion coated is provided as an amorphous polyester, which allows for the heat seal material to be coextrusion coated and for the resultant layer to be heat-sealable. Amorphous polyesters include, for example, glycol-modified polyesters (PET-G).

Amorphous polyesters do not comprise a melt temperature Tₘ, only a glass transition temperature T_{g}. Crystalline (or semi-crystalline) polyesters, on the other hand, exhibit a Tₘ and, typically, also a T_{g} since there is usually an amorphous portion comprised in the material besides a crystalized portion.

Amorphous polyesters are easy to handle in extrusion coating and coextrusion coating. (co-)extrusion coating typically applies very high temperatures, typically above 270° C. Amorphous polyesters are, typically, also suitable for being heat-sealed. In contrast, crystalline polyesters or PETs are typically not applied in (co-)extrusion coating since they do not melt (to become amorphous) until reaching a relatively high temperature, making them difficult to handle in the coextrusion coating process.

WO 2013/075713 A1 discloses a coextrusion coating method of making a packaging film comprising a transparent base film of PET which is coated with an additional layer, the additional layer being applied on the base film by coextruding a polyolefin layer and a PET-G welding layer to form the sheet. The packaging film is to be punched to lids to be welded to seal containers, such as cups.

Copolyesters are modified polyesters and comprise isophthalic acid modified (IPA-modified) copolyesters in which IPA has been introduced to the PET in various amounts. IPA-modified copolyesters may also, or alternatively, be denoted PETi, PETI, PET-I, PET/I, and/or isophthalic acid copolymerized PET.

IPA-modified copolyester materials are typically provided in a crystallized, granular state, typically making the granules whitish and opaque. When extruded and quenched, the IPA-modified copolyester can be put in amorphous form, allowing a quenched copolyester heat seal layer to remain amorphous and heat-sealable after manufacture of films in this manner. It is known to apply IPA-modified copolyester as a heat-sealable layer of packaging films extruded from a stender frame extruder, such as in biaxially oriented PET (BOPET) films. Such films are applied, for example, as film lids heat-sealed to packaging trays for packaging of e.g. meats. Such copolyester layer may be coextruded together with other layers of the film. The copolyester layer typically has a thickness of 1-2 µm.

IPA-modified copolyester is typically not marketed for or used in (co-)extrusion coating processes, which (as mentioned above) usually require extrusion at very high temperatures.

US 2015/258757 discloses packaging material comprising an inner layer film made of a PET-based resin having heat sealing properties and a substrate film, where a heat-sealing surface of the inner layer film comprises an IPA-modified PET resin. The substrate film may be a film of biaxially stretched PET, biaxially stretched polyamide, or biaxially stretched polypropylene. A packaging material which prevents an oily component contained in an adhesive of a patch from being adsorbed or transferred to the packaging material, and which has excellent heat sealing characteristics is provided in US 2015/258757.

US 2019/185660 discloses a laminate film for a packaging material comprising at least an inner layer film serving as a heat seal surface, a surface layer film of an IPA-modified PET resin and an easy-to-tear, unstretched resin film between the inner layer film and the surface layer film. The easy-to-tear, unstretched resin film comprises a blend of a PET-based resin and a second resin having a difference in SP value from the PET-based resin.

US 2006/257646 discloses a film comprising a core layer comprising a polyester with a crystallinity value greater than 35%, a first and a second lap sealable layer on surfaces of the core layer comprising a polyester, e.g. an IPA-modified polyester, with a crystallinity value less than 35% and substantially spherical particles. The film may be produced in an extrusion casting method.

Both extrusion from a stender frame extruder, extrusion coating, and coextrusion coating are well-known processes for manufacture of packaging films.

A stender frame extruder includes a flat nozzle from which the film is extruded.

In extrusion coating, a carrier foil or base film (or substrate sheet) is moved between a cooling roller and a counter roller. The base film is a film that may be rolled off from roller. One or more layers, specifically a thermoplastic polymeric melt or melt curtain thereof extruded from a die, is/are applied between the foil and the cooling roller in a continuous process. Upon contact with the cooling roller, the melt solidifies upon cooling or quenching, and upon contact with the carrier foil, the thermoplastic melt is adhered to the carrier foil. The result is a carrier foil coated with a thin layer of one or more layers of a thermoplastic material, which together form the manufactured packaging film.

Coextrusion (or “co-extrusion”) is another well-known process which involves extruding two or more materials through a single die of an extruder so that the extrudates merge and weld together into a laminar structure before chilling or quenching. Coextrusion can be employed in e.g. blown film extrusion, free film extrusion, and extrusion coating processes, the latter being referred to as coextrusion coating. In the context of the present disclosure, the term “(co-)extrusion” may refer to extrusion or to coextrusion.

In coextrusion coating, the two or more coextruded melts are extruded together from one common die and are coated in melted form or as a melt curtain on the base film or carrier foil so that the coextrusion coated layers adhere to the base film layer. Immediately after the application of the melt on the base film, the melt is chilled or quenched and solidified upon contacting the cooling roller. To improve adherence, a primer may be applied to the base film before the coextruded melt is applied to it.

The general principles of extrusion coating and coextrusion coating are described in WO 2018215606 A1, especially with reference to FIG. 8 thereof. The contents of this document are included in their entirety herein.

In such methods involving (co-)extrusion coating, the resultant film may be rolled up on a roller, which may be transported to a packaging site where it may be rolled off and potentially cut or punched or otherwise adapted to a size suitable for a package to which it is to form part, potentially after having been heat-sealed thereto.

The term “film” as used herein may alternatively be denoted and may be interchangeable with the term “foil”. A film may generally consist of one or more sequential layers. Films may exist rolled up on rolls or freely and may be cut or punched or otherwise adapted in size from a larger film to form a smaller sized film or a piece or sheet of the film.

### SUMMARY

According to the present disclosure, a method of manufacture of a heat-sealable packaging film comprises:
providing a base film mainly comprising polyethylene terephthalate, the base film forming a layer of the manufactured packaging film;
providing a heat seal layer material mainly comprising an at least semi-crystallized and isophthalic acid modified copolyester comprising at least 5 weight% isophthalic acid; and
extrusion coating the heat seal layer material on the base film so that, in the manufactured packaging film, the heat seal layer material forms an exterior, amorphous, and heat-sealable heat seal layer.

In the context of the present disclosure, it has been shown that such isophthalic acid modified (IPA-modified) copolyesters can be (co-)extrusion coated on a polyester base film to form a heat-sealable layer of a packaging film. Furthermore, a potential better temperature resistance of such copolyesters has the effect that such packaging films can be more readily recycled, especially in known recycling processes in which materials of waste packaging films are treated or dried at temperatures, such as hot air temperatures, e.g., of about 140° C. The waste may be post-consumer waste.

In such recycling processes for extraction of polyester from waste for waste recycling, the waste can include waste from the packaging films according to the present disclosure and/or an object to which the packaging film was heat-sealed. Such waste can be collected in a first step and additional amount of potentially non-recycled polyester or PET may be added to the waste during the recycling process to potentially lower the amount of IPA-modified polyester in the recycled product. The collected waste can then be transported, potentially in bales, to a sorting facility where a polyester fraction of the waste can be separated, such as by means of infra red (IR) or near infra red (NIR) and/or a visual (VIS) spectrometry sensor. The polyester waste can then be subjected to an alcalic hotwash. Then, the waste can be shredded or ground into flakes after which the flakes can be washed, e.g. to remove contaminants. A further alcalic hotwash can then be performed. The flakes can then be dried, potentially by means of dry air blowing, potentially in an oven, potentially at a hot air temperature of e.g. 140 to 160° C. The waste from the packaging films according to the present disclosure may here at least partly recrystallize, which may at least partly prevent the flakes from agglomerating. The flakes can then be extruded, potentially to form an extruded granulate. The extruded recycled polyester granules can be subjected to recrystallization and/or solid state polymerization. Before use of the reused polyester, the polyester granules may similarly be dried again in a manner similar to the drying step described above.

It is noted that the methods and packaging films of the present disclosure are not limited by the theories or effects explained above or otherwise herein unless otherwise indicated.

It has been realized that prior art packaging films comprising a (co-)extrusion coated heat-sealable layer of PET-G or another type of amorphous polyester may not be suitable for being recycled in such recycling processes. PET-G may become sticky already at about 80° C. or less. The stickiness of PET-G at relatively low temperatures means that the material will to a higher degree agglomerate during such recycling processes, especially during one or more drying steps. This can also be the case in the drying process carried out before reusing the recycled polyester. Furthermore, recrystallization of polyester waste which includes larger amounts of PET-G may not be possible. It has been realized that IPA-modified copolyesters can alleviate these issues. Thus, in an example, the base film and/or the heat seal layer material does not comprise glycol-modified PET-G.

Furthermore, it has been realized that heat-sealing properties of an IPA-modified copolyester heat seal layer of packaging films according to the present disclosure can also be made to be satisfactory.

The films disclosed herein may be flexible and may be used as lids for containers or other packaging applications where a heat-sealable, potentially flexible, packaging film is relevant to apply.

The methods of manufacture according to the present disclosure can further comprise providing a coextrusion coating tie layer material mainly comprising a thermoplastic polymer, wherein the extrusion coating involves coextrusion coating the tie layer material and the heat seal layer material on the base film so that, in the manufactured packaging film, the heat seal layer material forms an exterior, amorphous, and heat-sealable heat seal layer and the tie layer material forms a tie layer disposed between the base film and the heat-seal layer.

In the present disclosure, expressions such as “extrusion coated on” and “coextrusion coated on” does not necessarily involve that the (co-)extrusion coated layer(s) is/are coated directly on a base film; rather, one or more further layers, such as an extrusion coating primer as described below, may be present in between.

The heat seal layer copolyester may have an IPA content of 2 to 30, 5 to 25, 5 to 20, 5 to 15, 6 to 14, 7 to 13, 8 to 12, or 9 to 11 weight%. At such IPA contents, the heat seal layer may be applied by (co-)extrusion coating and may be heat-sealable, while allowing for the copolyester to be recycled in common recycling processes, potentially together with the PET of the base film.

The heat seal layer material may be a starting material for the heat-seal layer and may be provided before the (co-)extrusion coating, potentially as a crystallized or semi-crystallized resin, especially at ordinary storage temperatures, such as below 50° C.

The heat seal layer material may be provided as a substantially opaque, potentially white or whitish, material. The heat seal layer material may be provided as a solid and/or granular material, potentially in the form of granules.

The base layer may have a polyester concentration of more than 50, 60, 70, 80, 90, 95, 98, 99, 99.5, or 99.9 vol%. The heat seal layer material may have a copolyester concentration of more than 50, 60, 70, 80, 90, 95, 98, 99, 99.5, or 99.9 vol%. The heat seal layer material may have an additive concentration of less than 1, 0.5, or 0.1 vol%. The heat seal layer material may have a melting point Tₘ of above 180, 190, 200, 210, or 220° C. The heat seal layer material may have a melting point Tₘ according to ASTM D3418 from 190 to 250, 200 to 250, 210 to 250, 215 to 245, 220 to 240, or 225 to 235° C.

The heat seal layer material may be heated to above its Tₘ and may be on a melted and/or amorphous form during the (co-)extrusion coating step and may be in an amorphous, solid form in the manufactured packaging film.

The heat seal layer material may be (co-)extrusion coated at a temperature thereof at or above 240, 250, 260, 265, 270, 275, 280, 285, or 290° C.

In the case of coextrusion coating, the coextrusion coating may be performed in an extruder, which comprises a feedblock. A temperature of the heat seal layer material in the feedblock or a temperature set in the feedblock may be 250 to 300, 260 to 290, or 270 to 280° C.

During or after (co-)extrusion coating of the heat seal layer material, the (co-)extrusion coated layer(s) may be quenched or rapidly cooled, such as cooled by more than 200° C./s. This may allow the heat seal layer material to substantially maintain an amorphous form in the manufactured packaging film, which can allow the manufactured heat seal layer to be heat-sealable. The quenching may vitrify or glassify the heat seal layer material, potentially so that the heat seal layer of the manufactured packaging film is in an amorphous state.

The heat seal layer material may have a relative density of more than or equal to 1.2, 1.3, or 1.35, such as 1.37 g/m³, and/or a bulk density of 0.8 to 0.9, such as 0.84 g/m³, and/or a specific density crystalline above 1.3 or 1.35, such as 1.39, g/m³.

The heat seal layer material may have a crystallinity according to ASTM D1505 above or equal to 20, 25, 30, 35, 40, or 45, such as 48, %. The heat seal layer material may have recommended processing temperatures from 265 to 275° C.

The copolyester may be Selenis Copolyester Crystallized Resin, having the trade dame Bondz BO 035, according to data sheet dated 17/05/2016, updated 16/07/2019. This copolyester is designed for sealing layers in BOPET films. This copolyester is provided as opaque white, solid granular material and has a copolyester concentration of more than 99.9 % and an additive concentration of less than 0.1 % and a melting point of above 220° C. The relative density is more than or equal to 1.37 g/m³, bulk density 0.84 g/m³, specific density crystalline above 1.39 g/m³. The crystallinity according to ASTM D1505 is above or equal to 48 %. The melting point according to ASTM D3418 is 225 to 235° C. Recommended processing temperatures are 265 to 275° C.

Before the (co-)extrusion coating step, the heat seal layer material may be heated, potentially in an oven, to above 100, 110, 120, 130, 135, or 140° C. This may occur before providing the material to a feed zone of an extrusion coating or coextrusion coating apparatus or machine.

The potential coextrusion coating tie layer(s) may at least contribute to tying or bonding the heat seal layer to the base film.

A sheet or a sheet lid may be punched or cut from the packaging film before, during, or after heat-sealing the packaging film to another object.

The base film may be metallized, such aluminized, or may comprise a metallization layer or coating, such as an aluminum layer or coating, on an exterior surface and/or on a surface of facing the heat-sealable layer. This may provide improved barrier properties of the manufactured packaging film.

The base film can have a thickness of 23 to 50 or 30 to 40 µm, which may especially be relevant if the packaging film is for use as lids for containers. The base film can have a thickness of 20 to 100, 20 to 80, 20 to 60, 20 to 50, 20 to 40, or 20 to 30 µm. The base film can have a thickness of 40 to 100, 40 to 80, or 50 to 70 µm, which may especially be relevant if the packaging film is for use as a top web of a blister package. The base film may be a laminate comprising two or more laminated layers or films, which may also especially be relevant if the packaging film is for use as a top web of a blister package, potentially to increase tear strength of the packaging film. Examples of the latter include two PET layers of, e.g., 36 and 23 µm or 50 and 12 µm, respectively, wherein the latter layer may be a metallized PET layer. This may be of advantage since thinner metallized films may be cheaper.

The (co-)extrusion coated layer(s) can be (co-)extrusion coated in a total grammage of 8 to 25, 8 to 20, 10 to 20, 12 to 20, or 16 to 18 g/m².

The copolyester may be dried, such as for 4 to 6 hours, before the (co-)extrusion coating.

If the method involves coextrusion coating as described above, when the packaging film has been heat-sealed or welded to another object, such as a container or tray, and the packaging film is subsequently pulled off the object, e.g. to open the container, delamination or split peel may occur within the coextrusion coated layers, e.g. between the tie layer and the heat seal layer or between two tie layers. Alternatively, delamination may occur between the or a tie layer and the base film or between the heat seal layer and the object. Upon peeling off the packaging film from the object, the layer(s) closer to the object than the delamination may break or tear around a heat seal area, allowing the object, which the packaging film is/was covering, to be opened. The force for delaminating may be 5 to 12 N/15 mm or lower depending on the desired purpose of the packaging film. This force can be varied by varying the thickness of the heat seal layer.

The packaging film may form one coherent film and/or the base film and (co-)extrusion coated layers may all adhere to each other, which adherence may at least partly be established by the (co-)extrusion coating.

The base film may be or may alternatively be denoted a substrate film, or a substrate film.

The entire packaging film and/or the base film and/or the tie layer and/or one or more further tie layers and/or the heat seal layer may be transparent or translucent or may be opaque and/or may comprise a colorant and/or may be colored. A colorant, such as titanium dioxide, may be included in or on any one of the latter layers.

The base film may, in itself, comprise more than one layer. The base film may have been manufactured before the methods according to the present disclosure. The base film may comprise one or more layers comprising or substantially consisting of PET. The base film may additionally comprise a metallized layer or metallization, a barrier coating or barrier layer, a print or print layer, and/or a protection layer forming part of the base film layer. Such layers and coatings may be provided on a first and/or second major surface of the PET layer. Such layers or coatings may additionally or alternatively be provided on either one of the two major surfaces of the base film.

The base film may comprise or essentially consist of, potentially one or more layers of, polyester or PET, potentially oriented, potentially biaxially oriented, PET (OPET; BOPET).

The base film may be or comprise a separately extruded and/or coextruded, potentially extrusion blown, film and/or extrusion coated or coextrusion coated film.

A function of the tie layer may be to promote adherence between the heat seal layer and the base film. Two or more tie layers may be formed in the coextrusion coating, wherein the tie layer, which is adjacent to the base film, may provide adherence to the base film, and the tie layer, which is adjacent to the heat seal layer, may provide adherence to the heat seal layer. Similarly, the two or more tie layers may adhere to each other, respectively.

The packaging film, base film, one or more tie layers, and/or heat seal layer may be distributed to have substantially uniform thickness or grammage across substantially an entire planar extent of the packaging film.

The base film may have a first major surface which may face a or the tie layer and an opposite, second major surface, which may be an outer major surface for facing the environment when the packaging film has been attached to an object.

An extrusion coating or coextrusion coating primer may be applied to a surface of the base film prior to the application of the (co-)extrusion coating on that surface. This may achieve enhanced adhesion between the base film and (co-)extrusion coated layer(s). In some examples, no such primer layer is present, whereby the at least one tie layer may be positioned to coincide directly with a major surface of the base film.

Such an extrusion coating primer may comprise or essentially consist of a substantially water soluble or a substantially water insoluble primer and may be selected from the group consisting of:
a polyurethane (PU) based primer, in some examples with reactive isocyanate groups;
a polyurethane/polyvinyl buthylene (PvB) based primer;
a polyurethane/nitrocellulose (NC) based primer;
a hotmelt primer based on UV hardening technology;
a polyethylenimine based primer;
an acrylic based primer; and/or
a combination of the above.

Other primer types may also be suitable.

The primer may be applied in a grammage of 0.01 to 0.1, such as 0.04, g/m² dry weight.

Potentially enhanced adhesion between the base film and the (co-)extrusion coated layers achieved by using a primer layer may allow delamination to be controlled.

The base film may comprise at least 50, 60, 70, 80, 90, 95, 99, 99.9, or substantially 100 % by weight of polyester, PET, OPET, or BOPET. The base film may comprise small amounts or residues of additives, such as anti-block agents, release agents and the like. The base film may comprise a colouring agent and may be white or another colour. The base film may comprise one or more colouring agents to make the resultant packaging film non-transparent or opaque, which is especially relevant in case the packaging film is used for packaging of dairy products, such as yoghurt, where a thin film of the dairy product will often adhere to a bottom surface of the sheet lid, making transparency undesirable for aesthetic reasons.

As mentioned above, the base film may comprise further layers such as a barrier coating or metallization. The barrier coating may comprise or essentially consist of polyvinylidene chloride (PVdC) and/or a ceramic barrier material, the latter potentially being selected from the group consisting of aluminium oxide (AlOx), silicon oxide (SiOx), magnesium oxide, cerium oxide, hafnium oxide, tantalum oxide, titanium oxide, yttrium oxide, zirconium oxide and mixtures thereof.

The base film may be metallized on its second major surface facing away from the heat seal layer, in which case the metal coating is exposed and may be provided with an outer protective lacquer to prevent the metal layer from being scratched or damaged. Alternatively, the metal coating can be disposed on the first major surface of the base film between the base film and (co-)extrusion coated layers, in which case a or the tie layer and/or primer may have sufficient adherence so as to avoid undesired delaminating of the packaging film.

No further layer(s) need be provided on the base film top major surface. No further layer(s) need be provided beneath the heat seal layer. In some examples, no further layers are included in the packaging film besides the base film and the (co-)extrusion coated layer(s). In some examples, the coextrusion coated layers only comprise at least one tie layer, such as one or two tie layers, and the heat seal layer. In some examples, the tie layer or each of the tie layers and the heat seal layer are only one single layer, i.e. they comprise no sublayers. The (co-)extrusion coated layer(s) may comprise only the potential tie layer(s) and the heat seal layer, but one or more other layers may be present, such layers potentially being coextrusion coated together with the potential tie layer(s) and/or the heat seal layer. In some examples, only materials for providing an improved adhesion are provided between the heat seal layer and the base film.

The base film and/or the (co-)extrusion coated layer(s) and/or the potential tie layer(s) and/or the heat seal layer and/or the packaging film may be transparent and/or translucent and/or may allow at least 10 %, 25 %, 50 %, 60 %, 70 %, 80 %, 90 %, 95 % or substantially 100 % of visible light to pass through. Alternatively, the base film and/or the tie layer(s) and/or the packaging film may be opaque, i.e. allowing substantially no visible light transmission through it.

The one or more potential tie layer(s) may comprise at least 50 % by weight polyolefin(s), e.g., at least 60, 70, 80, 90 or 95 % by weight or substantially 100 % by weight. A polyolefin may be defined as the class of polymers produced from a simple olefin (also called an alkene with the general formula CnH₂n) as a monomer. For example, polyethylene (PE) is the polyolefin produced by polymerizing the olefin ethylene. Polypropylene (PP) is another common polyolefin which is made from the olefin propylene. The polyolefin(s) may be, comprise or substantially consist of a thermoplastic polyolefin and/or a poly-α-olefin. The degree of crystallinity of the polyolefin(s) may be above 60 %, 70 %, 80 % or 90 %. The polyolefin may be, comprise or substantially consist of PE or may alternatively or additionally be, comprise or consist of PP. The polyolefin, including e.g. PE and/or PP, may be in the form of a homo-polymer or a co-polymer of the polyolefin.

The potential tie layer(s) may be, comprise, or consist of a PE containing acrylate or methyl acrylate of which the acrylate or methyl acrylate content may be equal to or above 10, 15 or 20 weight %. The potential tie layer(s) may additionally or alternatively be, comprise or consist of a PE containing anhydride or maleic anhydride. The anhydride or maleic anhydride content may be equal to or above 0.1, 0.2 or 0.3 weight %. The potential tie layer(s) may be, comprise or consist of a terpolymer of ethylene, acrylic ester and/or maleic anhydride. The melt index (190°/2.16 kg) of the potential tie layer(s) may alternatively or additionally be 5 to 10 g/10 min measured according to the standard ISO 1133/ASTM 1238. The potential tie layer(s) may be, comprise or consist of Lotader 4503 as marketed by Arkema in January 2015. The potential tie layer(s) may be, comprise or consist of an ethylene vinyl acetate (EVA) and/or ethylene acrylic acid (EAA) and/or ethylene methacrylic acid (EMAA) and/or a copolymer or copolymer resin based on such materials, all potentially containing PE, which materials may be used in case of a metallized base film. The potential tie layer(s) may be, comprise or consist of an EMAA, the methacrylic acid content or methacrylic acid comonomer content of 3 to 10, 4 to 9, 5 to 8, 6 to 7 or about 6.5 wt%, such as Nucrel® 0609HSA as marketed by DuPont as of July 2010. The potential tie layer(s) may comprise a mixture of the above examples. The potential tie layer(s) may consist of a single tie layer, i.e. no further tie layers being present in the packaging film.

In case two tie layers are present, the tie layer adjacent the heat seal layer may be, comprise, or consist of an EVA, specifically an EVA copolymer resin, such as marketed by ExxonMobil under the trade name Escorene™ Ultra UL 00728EL, and that the tie layer adjacent the base layer is, comprises or consists of an EAA, specifically an EAA or EMAA copolymer resin, such as marketed by ExxonMobil under the trade name Escor™ 5110. The vinyl acetate content of a tie layer comprising EVA or of the EVA of such tie layer may be 20 to 40 or 25 to 30 wt%, the ethylene content potentially making up substantially the remaining parts of the material, i.e. 60 to 80 or 70 to 85 wt%. The acrylic acid content of a tie layer comprising EAA or of the EAA of such tie layer may be 5 to 15 or 9 to 13 wt%.

Alternatively, the tie layer adjacent the heat seal layer is, comprises or consists of a PE containing acrylate or methyl acrylate as mentioned above, and the tie layer adjacent the base layer is, comprises or consists of an EAA or EMAA copolymer resin as mentioned above.

Any and all of the above options regarding compositions, thicknesses etc. of the different layers may be combined. The same goes for the examples of this disclosure described below, e.g. with regard to temperatures.

Generally, in this specification, when terms such as “the tie layer material” and “the heat seal layer material” are used, such terms may indicate the material that will eventually or ultimately form the respective layer in the packaging film that results from the method of manufacture. Thus, for instance, the heat seal layer material is the initial or start material that is fed into an extruder, flows through the extruder, and eventually is applied as the heat seal layer of the resultant packaging film. Such a layer material has a temperature before being fed, in the different sequential zones inside the extruder, such as in a feedblock, and when being coated together with the other layer(s) of the (co-)extrusion coated layers onto the base film. Such temperature may vary during the sequence of the (co-)extrusion coating, and/or the temperature of different materials may vary differently and may be different from each other in the sequential steps and/or extruder zones during the (co-)extrusion coating. The temperature of such a material may be a maximum temperature of any part or every part or substantially any or every part of the material, especially in case an upper range limit is defined, or a minimum temperature of any or every part or substantially any or every part of the material, especially in case a lower range limit is defined. Local temperature variations of a layer material may occur. In case a single temperature is defined, such temperature may be a mean or average temperature of all parts of the material.

During the (co-)extrusion coating, each of the potential tie layer material(s) and the heat seal layer material may melt in the extruder to become melts of the respective materials. The temperature of the material may generally be the temperature of the material when being fed, or, when it is melted, the melt. However, it may alternatively be measured at an inner surface of the apparatus enclosing a zone in which the melt flows or it may be the set temperature, which is set for a temperature zone in the extruder apparatus.

Each of the potential tie layer material(s) and the heat seal layer material may in the methods according to the present disclosure generally be fed into a feed block through a respective separate feeder, which may comprise a worm or other means for transporting the materials through the feeder and into the feed block. As is common in extruders/coextruders, i.e. apparatuses for extruding films comprising thermoplastic polymer materials, each feeder may comprise an initial feed zone, followed by a transition zone, followed by a metering/mixing zone, followed by an adapter and melt pipe zone, which leads into the feed block. Each zone may comprise one or more subzones, which may also be referred to as “zones” herein. In the feed zone the starting material fed into the feeder is softened and heated almost to the melting point. In the transition zone the material is melted to form a melt of the material, and pressure is built up. In the metering/mixing zone a uniform melt is created. In the adapter/melt pipe zone the material is transferred to the feed block. In a feed block upper zone and a feed block lower zone, structure is built up in the material(s) to be (co-)extruded. The melt(s) are then (co-)extruded from one single common die of the extruder. The feeder, the feed block, the adapter/melt pipe and/or the die may comprise one or more heaters or heating elements (and potentially coolers) that may be regulated by one or more regulators. The heaters may be set to heat the materials within the extruder to a given temperature in each of the zones. One or more of the heaters may be in the form of a mantle or casing that surrounds or encases a zone, e.g. as an outer tube. Heat energy may also be created due to friction within the extruder and especially within the feeder. When referring to a temperature within a zone in this context, reference is made to one or more of the set temperature, a mean temperature of the material or melt in the zone, a maximum temperature of the material or melt in the zone, a minimum temperature of the material or melt in the zone, a temperature measured at one point in or at the material or melt of the zone, a temperature of the heating element, and a temperature measured on or at an inside surface of the extruder in the respective zone. Usually, these temperatures will be close to each other although locally a temperature may divert with some °C. The feed block may as mentioned comprise an upper and a lower zone, the upper zone being positioned subsequent to the adapter and melt pipe, and the lower zone leading into the die from which the melt is extruded. The die may comprise three interior zones in a transverse direction, each of the three interior zones may have two or three subzones in said transverse direction. In case of coextrusion coating, the melts or extrudates within the die merge and weld together into a laminar structure to form the coextruded layers that are coated onto the base film before chilling or quenching. Chilling or quenching can be carried out by applying the (co-)extruded layer(s) or the packaging film onto a cooling roller in a subsequently performed coating step of the (co-)extrusion coating process. In the coating step, the melt(s) is/are extruded onto the base film so that the (co-)extruded layers adhere to the base film. The (co-)extrusion coated layers and the base film are guided through a nip between the cooling roller and an opposed pressure roller, and pressure may be applied between the two rollers, the (co-)extruded layers may face the cooling roller, and the base film may face the pressure roller. As mentioned, a primer may be applied to the base film before the (co-)extruded melt is applied onto it. The base film may be (co-)extruded before the (co-)extrusion. A potential primer may be applied immediately before the (co-)extrusion coating.

In some examples, the methods of manufacture according to the present disclosure further comprise providing one, two, or more coextrusion coating tie layer material(s), which may mainly comprise a thermoplastic polymer, wherein the extrusion coating can involve coextrusion coating the tie layer material(s) and the heat seal layer material on the base film so that, in the manufactured packaging film, the heat seal layer material forms an exterior, amorphous, and heat-sealable heat seal layer and the tie layer material(s) form(s) a tie layer or tie layers disposed between the base film and the heat-seal layer.

In some examples of the methods and packaging films of the present disclosure, the copolyester has an isophthalic acid content of 5 to 15 weight%. Lower amounts of IPA may make the heat seal layer material more crystalline or provide a higher crystallinity and/or may make the properties of the material more like unmodified PET. Higher amounts may lower the Tₘ of the material, potentially making the material more suitable for or easier to extrusion coat or coextrusion coat and/or subsequent heat-sealing, but potentially less suitable for being recycled.

In some examples of the methods and packaging films of the present disclosure, the heat seal layer material has a melting point Tₘ according to ASTM D3418 from 200 to 240° C.

In some examples of the methods and packaging films of the present disclosure, the heat seal layer of the manufactured packaging film has a recrystallization temperature of equal to or above 70° C. and equal to or below 180° C. This temperature may be equal to or above 100° C. and equal to or below 160° C. or equal to or above 120° C. and equal to or below 150° C.

In some examples of the methods of manufacture of the packaging films of the present disclosure, the heat seal layer material has a crystallinity according to ASTM D1505 above or equal to 30 %.

In some examples of the methods of manufacture of the packaging films of the present disclosure, the heat seal layer material is provided as a solid, granular material.

In some examples of the methods and packaging films of the present disclosure, the heat seal layer material has a copolyester concentration of more than 99 vol%.

In some examples of the methods and packaging films of the present disclosure, the thermoplastic polymer of the tie layer material is polyolefin.

In some examples of the methods of manufacture of the packaging films of the present disclosure, the extrusion coating is performed in an extruder, which comprises a worm or screw, wherein the heat seal layer material is heated to above 100° C. before and/or at an entry into the worm or screw. Alternatively, the heat seal layer material is heated to at or above a glass transition temperature of the heat seal layer material. This may make the extrusion coating or coextrusion coating possible or easier to perform, especially since the material may be softer when being transported through the worm or screw. This may be achieved by introducing the heat seal layer into the worm or screw immediately after drying or immediately from a heated drying chamber. These temperatures may be above 110, 120, 130, 135, or 140° C. A first temperature zone of a worm or screw or a feedblock may be heated to or set to a temperature of above 200, 210, 220, 230, 240, 250, or 255° C., which may further contribute to this effect.

In some examples of the methods and packaging films of the present disclosure, the base film has a thickness of 23 to 50 µm, and the (co-)extrusion coated layer(s) is/are coated in a total grammage of 8 to 20 g/m². The base film may have a thickness of 10 to 100, 20 to 60, 25 to 45, or 30 to 40 µm. Additionally, or alternatively, the total grammage of the (co-)extrusion coated layers can be 5 to 30, 5 to 25, 5 to 20, 8 to 18, 10 to 18, or 12 to 16 g/m². Additionally, or alternatively, the heat seal layer can be distributed in a grammage of 2 to 30, 2 to 25, 2 to 20, 2 to 15, 2 to 10, 5 to 15, 5 to 11, 6 to 10, 3 to 8, 5 to 8, or 3 to 6 g/m². Additionally, or alternatively, if the coextrusion coated layers comprise a or one tie layer, the tie layer can be distributed in a grammage of 2 to 20, 2 to 15, 2 to 10, 10 to 20, 12 to 18, 13 to 17, 5 to 15, 5 to 11, 6 to 10, 3 to 8, 5 to 8, or 3 to 6 g/m².

The present disclosure also involves a method of manufacture of a package, the method comprising:
manufacturing or providing the packaging film according to the method of any one of the examples as disclosed herein; and
heat-sealing the packaging film to an object so that the heat seal layer faces the object.

The present disclosure also involves a heat-sealable packaging film, comprising:
a base film mainly comprising polyethylene terephthalate, the base film forming a layer of the packaging film; and
a heat seal layer mainly comprising an isophthalic acid modified copolyester comprising at least 5 weight% isophthalic acid;
wherein the heat seal layer has been extrusion coated on the base film so that the heat seal layer material forms an exterior, amorphous, and heat-sealable heat seal layer.

Such packaging films may be manufactured according to any one of examples of methods of the present disclosure. Any one or more of the characteristics of the manufactured packaging films explained in connection with the above examples of packaging films and methods of manufacture thereof and can also apply to any one or more of the examples of packaging films as disclosed immediately above. For example, any and all of the above examples of thicknesses, contents etc. of the different layers and their properties and described above in relation to the methods of the present disclosure for manufacture of packaging films can individually or combined apply to the packaging films. Similarly, the packaging films can also include a coextrusion coating tie layer mainly comprising a thermoplastic polymer, wherein the tie layer and the heat seal layer have been coextrusion coated on the base film so that the heat seal layer material forms an exterior, amorphous, and heat-sealable heat seal layer and the tie layer material is disposed between the base film and the heat-seal layer.

The heat seal layer and the potential the tie layer(s), have been extrusion coated, potentially coextrusion coated, on the base film, which can be determined from such packaging films since the (co-)extrusion coated layer(s) will in that case adhere to the base film without a separate adhesive layer being provided between the two layers. If a separate adhesive layer is provided, the packaging film can be seen to have been manufactured by adhesive lamination. Accordingly, there may not be a separate adhesive layer or glue layer that includes a hardener or a hardening agent/component, present between the (co-)extrusion coated layer(s) and the base film. An adhesive or glue layer that includes a hardener or a hardening agent/component may be defined as a layer that comprises or essentially consists of a two-component adhesive or a two-component glue such as a polyurethane (PU) based adhesive/glue, available from, for example, Henkel AG, Coim Spa or Dow Chemical. Such an adhesive layer will have a much larger thickness or grammage than an extrusion coating primer layer. Alternatively, it can be determinable from a packaging film that the heat seal layer, and potentially the tie layer, has/have been extrusion coated, potentially coextrusion coated, onto the base film since in that case the packaging film will have very small curl compared to if it were manufactured by adhesive lamination.

The present disclosure also involves a package comprising a sheet or lid of the packaging film according to the disclosure and an object, wherein the sheet or lid is heat-sealed to the object with the heat seal layer facing the object, and wherein the package comprises a packaged product.

The package may be a packaging or packet. The object may be tray or cup, or a bottom film or bottom web of a blister package, the bottom web potentially including blister cavities for e.g. pills or tablets. In this case, the packaging film may form a top web of the blister package. The packaged product may be or comprise a solid or a liquid. The package may be or comprise a blister package, potentially for tablets or pills. The packaged product may comprise a foodstuff product, such as a dairy product, and/or a pharmaceutical product. The object may be a container or tray and/or may comprise or consist of PET and/or may include a heat seal surface comprising or consisting of PET.

The present disclosure also involves a method of recycling the packaging film of any one of the above examples, wherein a waste material from the packaging film is dried at above 100° C.

During the drying, at least part of the packaging film waste may at least partly recrystalize.

The methods of recycling according to the present disclosure can involve one or more of, or all the following steps, potentially in sequence:
Collected waste substantially consists of polyester waste and/or a polyester fraction of the waste is separated, such as by means of infra red (IR) or near infra red (NIR) and/or a visual (VIS) spectrometry sensor
The waste is washed, such as as subjected to an alcalic hotwash.
The waste is shredded or ground after which the flakes may be washed, e.g. to remove contaminants after which a further alcalic hotwash can be performed.
The flakes are dried at above 100° C., potentially by means of dry air blowing, potentially in an oven, potentially at a hot air temperature of e.g. 140 to 160° C. The waste may here at least partly recrystallize, which may at least partly prevent the flakes from agglomerating.
The flakes are extruded, potentially to form an extruded granulate.
The extruded recycled polyester granules are subjected to a recrystallization and/or solid state polymerization.

Before use of the reused polyester, the polyester granules can similarly be dried again in a manner similar to the drying step described above.

### BRIEF DESCRIPTION OF THE DRAWINGS

In the schematic drawings:

FIG. 1 shows a side view of a first example of the heat-sealable packaging films of the present disclosure;

FIG. 2 shows a side view of a second example of the heat-sealable packaging films of the present disclosure;

FIG. 3 shows a side view of a third example of the heat-sealable packaging films of the present disclosure;

FIG. 4 shows a side view of a fourth example of the heat-sealable packaging films of the present disclosure; and

FIG. 5 shows a perspective view of a cup and a lid punched from the packaging film of FIG. 2.

### DETAILED DESCRIPTION

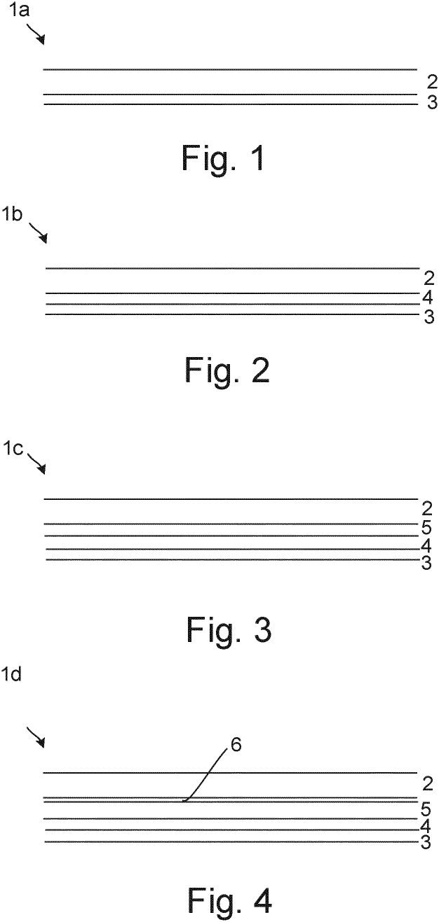

FIGS. 1 to 4 show first to fourth examples, respectively, of heat-sealable, flexible packaging films 1a to 1d of the present disclosure. The packaging films 1a to 1d have been manufactured according to examples of methods of the present disclosure. In the following, the same refence signs will be applied to designate identical or corresponding features of each of the packaging films 1a to 1d.

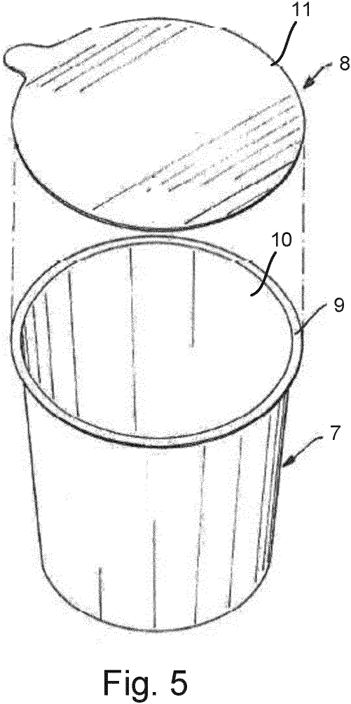

The films 1a to 1d can be used as lids for containers, see also below and FIG. 5, or other packaging applications where a heat-sealable, potentially flexible, packaging film is relevant to apply.

Each of the packaging films 1a to 1d comprises a base film 2 of extruded BOPET, the base film 2 forming a layer of each of the packaging films 1a to 1d. An exterior, amorphous, and heat-sealable heat seal layer 3 mainly is of an IPA-modified copolyester comprising about 10 weight% IPA. The heat seal layer 3 has been extrusion coated on the base film so that an initial or start material for the heat seal layer 3 after manufacture of the packaging films 1a to 1d forms the heat seal layer 3.

The packaging films 1b to 1d of FIGS. 2 to 4, respectively, also include a coextrusion coating tie layer 4 of a thermoplastic polymer. In manufacture of the packaging films 1b to 1d, the tie layer 4 and the heat seal layer 3 have been coextrusion coated on the base film so that, in the manufactured packaging films 1b to 1d, a start material for the heat seal layer 3 forms the exterior, amorphous, and heat-sealable heat seal layer 3 and a start material for the tie layer 4 is disposed between the base film 2 and the heat-seal layer 3. Consequentially, no adhesive or glue layer is present in the packaging films 1a to 1d.

Each of the packaging films 1a to 1d is manufactured by an associated example of the methods according to the present disclosure. First, the base film 2 is provided or manufactured, potentially manufactured in a previous process, and the heat seal layer material is provided. The heat seal layer material is provided as a substantially opaque, whitish, solid, granular material. The heat seal layer start material comprises the semi-crystallized and IPA-modified copolyester comprising at least 5 weight% isophthalic acid. Then, the heat seal layer material is extrusion coated on the base film 2 so that, in the manufactured packaging film 1a to 1d, the heat seal layer material forms the exterior, amorphous, and heat-sealable heat seal layer 3.

Each of the methods of manufacture of the packaging films 1b to 1d further comprises providing a coextrusion coating tie layer material of a thermoplastic polymer, wherein the extrusion coating involves coextrusion coating the tie layer material and the heat seal layer material on the base film 3 so that, in the associated manufactured packaging film 1a to 1d, the heat seal layer material forms the exterior, amorphous, and heat-sealable heat seal layer 3 and the tie layer material forms the tie layer 4 disposed between the base film 2 and the heat-seal layer 3. The packaging sheets 1c and 1d also include a second, further tie layer 5, which has been coextrusion coated together with the tie layer 4 and the heat seal layer 3. A not shown extrusion coating primer can be applied to the surface of the base film 2 facing the heat seal layer 3 before the (co-)extrusion coating of the heat seal layer 3 and, where relevant, the one or two tie layers 4, 5. The primer may be selected among the above-mentioned options.

The heat seal layer material can have a melting point Tₘ of about 230° C. In the (co-)extrusion coating process, the heat seal layer material is heated to its Tₘ so that it is on a melted and amorphous form. In the manufactured packaging films 1a to 1d the heat seal layer material is in an amorphous, solid form. The heat seal layer material can have a relative density of 1.37 g/m³, a bulk density of 0.84 g/m³, and a specific density crystalline above 1.3 or 1.35, such as 1.39, g/m³. The heat seal layer material can have a crystallinity according to ASTM D1505 of about 48 %.

The heat seal layer material can be (co-)extrusion coated at a temperature thereof at about 275° C. Coextrusion coating is performed in an extruder, which comprises a feedblock, and a temperature of the heat seal layer material in the feedblock or a temperature set in the feedblock can be 260° C. During the coextrusion coating, the (co-)extrusion coated heat seal layer 3, and the potential tie layer(s) 4 and 5, are quenched to allow the heat seal layer material 3 to substantially maintain its amorphous form in the manufactured packaging films 1a to 1d, which allows the manufactured heat seal layer 3 to be heat-sealable.

The copolyester of the heat seal layer material can, for example, be Selenis Copolyester Crystallized Resin, having the trade dame Bondz BO 035, as mentioned in the above.

Before the (co-)extrusion coating step, the heat seal layer material can be heated in an oven to about 140° C. before providing the material to a feed zone of an extrusion coating or coextrusion coating apparatus or machine.

The tie layers 4, 5 tie or bond the heat seal layer 3 to the base film 2.

In the packaging film 1d of FIG. 4, the base film 2 is aluminized so as to include a metallization coating 6 on a surface facing the heat seal layer 3.

The base film 2 can have a thickness of 36 µm. The (co-)extrusion coated layer(s) can be (co-)extrusion coated in a total grammage of, for example, 17 g/m².

The copolyester of the heat seal layer 3 can be dried for 4 to 6 hours before the (co-)extrusion coating.

Each of the packaging films 1a to 1d forms one coherent film in which the base film 2 and (co-)extrusion coated layers 3 and potentially 4, 5, adhere to each other in sequence. This adherence is established by the (co-)extrusion coating.

Each of the packaging films and their associated base film 2, tie layer(s) 4, 5, and heat seal layer 3 are distributed to have substantially uniform thickness and grammage across substantially an entire planar extent of the packaging film 1a to 1d.

The base film 2 can be opaque, translucent, or transparent. The base film 2 can comprise a colouring agent and may be white or another colour.

The packaging films 1a to 1d include no further layers, films, or materials. Each of the layers only comprises a single layer, i.e. no sub-layers. In other examples, the packaging sheets 1a to 1d may comprise a print layer on either side of the base film 2. If on an exterior surface of the base film 2, a protective lacquer may be provided to protect the print layer.

The material of the tie layers 4 and/or 5 can be Lotader 4503 or another of the extrusion coating tie layer materials suggested in the above.

The (co-)extrusion coating is generally performed in an extruder as explained in the above.

FIG. 5 shows an example of the packages of the present disclosure, in the form of a cup 7 of APET, and a film lid or sheet lid 8 pre-punched from the packaging film 1b of FIG. 2. The cup 7 comprises a seal rim 9 surrounding an opening 10 of the cup 7. A corresponding circumferential rim 11 of the lid 8 is heat-sealed to the rim 9 in a suitable heat-sealing tool with the heat heal layer 3 facing an upper seal surface of the rim 9. The cup can be filled with, for example, yogurt (not shown) before the cup 9 is closed and sealed in this manner. The lid 8 can then be torn off by a consumer to gain access to the packaging contents.

When a consumer later tears off the lid 8, the torn-off lid 8 can be disposed off as recyclable polyester, potentially together with the cup 7. According to an example of a method of recycling the lid 8, the lid 8 waste is separated and extracted, potentially together with further waste, such as the cup 7 waste, in a process where the waste is dried at, for example, about 140° C.

According to known processes of extraction of polyester from waste for waste recycling, polyester waste including waste from the packaging films according to the present disclosure, such as the torn-off lid 8, and/or an object to which the film was heat-sealed, such as the cup 7, can first be collected. The collected waste is then transported, potentially in bales, to a sorting facility where a polyester fraction of the waste can be separated, such as by means of infra red (IR) or near infra red (NIR) and/or a visual (VIS) spectrometry sensor. The polyester waste can then be subjected to an alcalic hotwash. Then, the waste can be shredded or ground into flakes after which the flakes can be washed, e.g. to remove contaminants, such as yogurt remains. A further alcalic hotwash can then be performed. The flakes can then be dried, potentially by means of dry air blowing, potentially in an oven, potentially at a hot air temperature of 140 to 160° C. The waste from the packaging films according to the present disclosure may here at least partly recrystallize, which may at least partly prevent the flakes from agglomerating. The flakes can then be extruded, potentially to form an extruded granulate. The extruded recycled polyester granules can then be (re-)crystallized to be ready for reuse. Before being reused, the granules may again be dried at a similar temperature.

### Experiments

Five different samples, Samples 1, 1a, 2, 3, and 4, of the packaging film 1b of FIG. 2 were manufactured by the method as explained above. The samples were provided with varying grammages of the coextrusion coated layers.

The base film 2 was a one-side corona-treated, 36 µm BOPET film, FLEX FF-PAP-36-N. The extrusion coating was performed on the corona-treated surface of the base film 2.

The tie layer material for the tie layer 4 was Lotader 4503 as described in the above.

The heat seal layer material for the heat seal layer 3 was Bondz BO 035 as described in the above. Before the coextrusion coating, the heat seal layer material was dried for 4-6 hours at 140° C.

Before the coextrusion coating, an extrusion coating primer was applied to the surface of the base film 2 for facing the heat seal layer 3. The primer was MICA A-131-X, a water based, modified polyethyleneimine, single component resin dispersion extrusion primer.

The cooling roller was a Teflon/metal roller, and the counter-roller was a silicone rubber roller. Other types of rollers, such as metal rollers, can alternatively be applied.

When coated, the tie layer melt was set to a temperature of 275° C., and the heat seal layer melt was set to a temperature of 290° C. The temperature in the feedblock and in the die was set to 275° C.

The manufactured packaging films were each heat sealed at 210° C. to a, APET cup in a manner similar to as disclosed above in connection with FIG. 5. The heat sealed packaging films were then subjected to two tests of heat seal strength. In the first test, the films were peeled off the cup, and the peel in the heat seal zone was manually evaluated and given a score from 1 to 5 out of 5 where 5 indicated an a highest score, uniform peel with suitable peel strength and without strings of material, and 1 indicated an unsatisfactory peel. The second test was a vacuum test in which the sealed cups (sealed at atmospheric pressure) were subjected to an atmospheric pressure of minus 200 hPa. The, it was manually observed whether the sealed cups remained sealed, i.e. whether the seal survived the sub-pressure, and the Samples were provided with a pass/fail score.

Theoretical applied grammages of the coextrusion coated tie layer material and heat seal material are shown in Table 1 below. A grammage of the resultant coextruded layers was measured after manufacture. The measured grammage was somewhat different from the theoretical grammages, which is expected to be due to a varying width of the coextrusion coating; the width was set to 0.54 m but varied somewhat and was not measured for the Samples.

TABLE 1

| Sample | Tie layer, theoretic grammage [g/m²] | Heat seal layer, theoretic grammage [g/m²] | Total theoretic grammage [g/m²] | Total measured grammage [g/m²] |
|---|---|---|---|---|
| 1 | 10.8 | 4.0 | 14.8 | 12.0 |
| 1a | 14.6 | 5.3 | 19.9 | 15.8 |
| 2 | 10.6 | 5.3 | 15.9 | 12.5 |
| 3 | 8.1 | 4.5 | 12.6 | 11.0 |
| 4 | 6.6 | 7.5 | 14.2 | 12.3 |

Table 2 below shows the results from the peel test and the vacuum test.

TABLE 2

| Sample | Peel test | Vacuum test |
|---|---|---|
| 1 | 4/5 | Fail |
| 1a | 5/5 | Pass |
| 2 | 4/5 | Fail |
| 3 | 5/5 | Fail |
| 4 | 5/5 | Pass |

All Samples could be heat sealed and subsequently peeled off. It was also observed that Samples 1, 1a, and 2 ran very well with a homogeneous coating, whereas there was a tendency of die swelling and a more heterogeneous coating in the manufacture of Samples 3 and 4. The Samples generally peeled (as intended) between the tie layer and the heat seal layer; however, Sample 1 peeled in the heat seal layer.

A differential scanning calorimetry (DSC) was performed on a Perkin-Elmer DSC-7 on the copolyester “waste” of a heat seal layer of one of the packaging films of the above experiments. The analysis indicated that the amorphous heat seal layer material started to recrystallize at about 120 to 140° C. At e.g. hot air drying at air temperatures at or above the recrystallization temperature, the waste can, therefore, be foreseen to agglomerate less upon heating than e.g. PETG based heat seal layers.

The packaging films of the Samples can be recycled according to any one of the methods of recycling as disclosed herein.

1. A method of manufacture of a heat-sealable packaging film, comprising:
providing a base film mainly comprising polyethylene terephthalate (PET), the base film forming a layer of the heat-sealable packaging film;
providing a heat seal layer material mainly comprising an at least semi-crystallized and isophthalic acid modified copolyester comprising at least 5 weight% isophthalic acid; and
extrusion coating the heat seal layer material on the base film, wherein, in the heat-sealable packaging film, the heat seal layer material forms a heat seal layer that is exterior, amorphous, and heat-sealable.

2. The method of claim 1, further comprising:
providing a tie layer material mainly comprising a thermoplastic polymer, wherein the extrusion coating involves coextrusion coating the tie layer material and the heat seal layer material on the base film, wherein, in the heat-sealable packaging film, the heat seal layer material forms the heat seal layer and the tie layer material forms a tie layer disposed between the base film and the heat seal layer.

3. The method of claim 1, wherein the at least semi-crystallized and isophthalic acid modified copolyester has an isophthalic acid content of 5 to 15 weight%.

4. The method of claim 1, wherein the heat seal layer material has a melting point Tₘ according to ASTM D3418 from 200 to 240° C.

5. The method of claim 1, wherein the heat seal layer material of the heat-sealable packaging film has a recrystallization temperature of equal to or above 70° C. and equal to or below 180° C.

6. The method of claim 1, wherein the heat seal layer material has a crystallinity according to ASTM D1505 above or equal to 30 %.

7. The method of claim 1, wherein the heat seal layer material is provided as a solid, granular material.

8. The method of claim 1, wherein the heat seal layer material has a copolyester concentration of more than 99 vol%.

9. The method of claim 2, wherein the thermoplastic polymer of the tie layer material is a polyolefin.

10. The method of claim 1, wherein the extrusion coating is performed in an extruder that comprises a worm or a screw, wherein the heat seal layer material is heated to above 100° C. before an entry into the worm or the screw, at the entry into the worm or the screw, or both.

11. The method of claim 1, wherein the base film has a thickness of 23 to 50 µm, and the heat seal layer material is extrusion coated in a total grammage of 8 to 20 g/m².

12. The method of claim 1, wherein the heat seal layer material is cooled by more than 200° C./s during or after the extrusion coating.

13. The method of claim 1, wherein the base film, the heat seal layer, or both, do not comprise glycol-modified PET (PET-G).

14. The method of claim 1, further comprising:
drying the heat seal layer material at a temperature above 110° C. before the extrusion coating.

15. A method of manufacture of a package, comprising:
providing a base film mainly comprising polyethylene terephthalate (PET), the base film forming a layer of a heat-sealable packaging film;
providing a heat seal layer material mainly comprising an at least semi-crystallized and isophthalic acid modified copolyester comprising at least 5 weight% isophthalic acid;
extrusion coating the heat seal layer material on the base film, wherein, in the heat-sealable packaging film, the heat seal layer material forms a heat seal layer that is exterior, amorphous, and heat-sealable; and
heat-sealing the heat-sealable packaging film to an object, wherein the heat seal layer faces the object.

16. A heat-sealable packaging film, comprising:
a base film mainly comprising polyethylene terephthalate, the base film forming a layer of the heat-sealable packaging film; and
a heat seal layer mainly comprising an isophthalic acid modified copolyester comprising at least 5 weight% isophthalic acid;
wherein the heat seal layer is formed by a heat seal layer material that has been extrusion coated on the base film, and wherein the heat seal layer is exterior, amorphous, and heat-sealable .

17. The heat-sealable packaging film of claim 16, wherein the heat-sealable packaging film does not comprise a polyurethane (PU) based adhesive between the base film and the heat seal layer.

18. The heat-sealable packaging film of claim 16, wherein the base film, the heat seal layer, or both, do not comprise glycol-modified PET (PET-G).

19. A package, comprising:
a sheet or lid of a packaging film; and
an object, wherein:
the packaging film comprises:
a base film mainly comprising polyethylene terephthalate, the base film forming a layer of the packaging film, and
a heat seal layer mainly comprising an isophthalic acid modified copolyester comprising at least 5 weight% isophthalic acid, wherein the heat seal layer is formed by a heat seal layer material that has been extrusion coated on the base film, and wherein the heat seal layer is exterior, amorphous, and heat-sealable,
the packaging film is heat-sealed to the object with the heat seal layer facing the object, and
the package comprises a packaged product.

20. The package of claim 19, wherein the packaged product comprises a foodstuff product and/or a pharmaceutical product.

21. The heat-sealable packaging film of claim 16, wherein the heat-sealable packaging film is configured to produce a waste material during a recycling process, and wherein the waste material is configured to dry at temperatures above 100° C.

22. The method of claim 2, wherein the base film has a thickness of 23 to 50 µm, and the heat seal layer material and the tie layer material are coextrusion coated in a total grammage of 8 to 20 g/m².
